(19) United States
(12) Patent Application Publication
(10) Pub. No.: US 2014/0169389 A1
(43) Pub. Date: Jun. 19, 2014

(54) OPTICAL RECEIVER MODULE USING WAVELENGTH DIVISION MULTIPLEXING TYPE

(71) Applicant: Electronics and Telecommunications Research Institute, Daejeon (KR)

(72) Inventors: Taeyong KIM, Daejeon (KR); JiHo JOO, Goyang (KR); Gyungock KIM, Daejeon (KR)

(21) Appl. No.: 13/941,038

(22) Filed: Jul. 12, 2013

(30) Foreign Application Priority Data
Dec. 14, 2012 (KR) 10-2012-0146842

(51) Int. Cl. H04B 10/60

(52) U.S. Cl. CPC H04B 10/60
USPC 370/536

(57) ABSTRACT

An optical receiver module includes a demultiplexer, an optical device including a right-angled mirror reflecting individual optical signals transmitted from the demultiplexer and a plurality of lenses receiving the reflected optical signals, and a plurality of photodetectors spaced apart from the plurality of lenses by a predetermined distance. The plurality of photodetectors converts the individual optical signals into electrical signals. The optical device and the demultiplexer are formed into a united structure. A distance between the lenses is equal to a distance between the photodetectors.

### CROSS-REFERENCE TO RELATED APPLICATIONS

This U.S. non-provisional patent application claims priority under 35 U.S.C. §119 to Korean Patent Application No. 10-2012-0146842, filed on Dec. 14, 2012, the entirety of which is incorporated by reference herein.

### BACKGROUND

The inventive concept relates to optical receiver modules and, more particularly, to wavelength division multiplexing (WDM) type optical receiver modules capable of increasing optical coupling efficiency between a demultiplexer and a photodetector.

Recently, as a speed and a capacity of optical communication increase, a wavelength division multiplexing (WDM) technique is applied to a backbone transmission network. The WDM technique employs multiple light wavelengths to transmit optical signals through a single optical fiber. An optical receiver module receives the optical signals of the different wavelengths. Additionally, the optical receiver module de-multiplexes the optical signals of the different wavelengths, such that the optical signals are divided into individual optical signals corresponding to channels, respectively. The optical receiver module converts each of the individual optical signals into an electrical signal and then transmits the electrical signal to an external circuit.

A photodetector used as an element of the optical receiver module receives light corresponding to the optical signal and then generates electron-hole pairs corresponding to the electrical signal. The photodetector is generally fabricated using semiconductor processes. A structure and materials of the photodetector may be determined depending on the purpose and the use of the photodetector.

The photodetectors may include a surface-illuminated type photodetector and a waveguide type photodetector. The surface-illuminated type photodetector receives light in a direction perpendicular to a surface and a bottom of a substrate. An aperture receiving light of the waveguide type photodetector is not formed at the surface and the bottom of the substrate but is formed at a cutting surface.

An aperture of the surface-illuminated type photodetector may be easily formed to have a desired shape, such that the surface-illuminated type photodetector may easily receive the light from an optical fiber. Thus, the surface-illuminated type photodetector may easily increase optical coupling efficiency. On the other hand, the waveguide type photodetector has the aperture of a quadrilateral shape such it has a low optical coupling efficiency.

The optical receiver module, which uses the surface-illuminated photodetector and a wavelength demultiplexer having an arrayed wavelength grating (AWG) structure, should change a traveling direction of light from a horizontal direction into a vertical direction by 90 degrees. However, optical alignment for transmitting the optical signal divided by the demultiplexer to the photodetector may be complex, such that fabricating costs of the optical receiver module may increase.

### SUMMARY

Embodiments of the inventive concept may provide optical receiver modules having a simple structure capable of transmitting an optical signal divided by a demultiplexer a photodetector through one optical alignment.

In an aspect, an optical receiver module may include: a demultiplexer dividing a plurality of multiplexed optical signals into individual optical signals; an optical device including a right-angled mirror and a plurality of lenses, the right-angled mirror reflecting the individual optical signals transmitted in a horizontal direction from the demultiplexer in a vertical direction, and the plurality of lenses receiving the individual optical signals reflected from the right-angled mirror; and a plurality of photodetectors spaced apart from the plurality of lenses by a predetermined distance, the plurality of photodetectors receiving the individual optical signals transmitted from the plurality of lenses, and the plurality of photodetectors converting the individual optical signals into electrical signals. The optical device and the demultiplexer may be formed into a united structure; and a distance between the lenses may be equal to a distance between the photo detectors.

### BRIEF DESCRIPTION OF THE DRAWINGS

The inventive concept will become more apparent in view of the attached drawings and accompanying detailed description.

FIG. 1 is a perspective view illustrating an optical receiver module according to some embodiments of the inventive concept;

FIG. 2 is a perspective view illustrating a lens array and a photodetector array included in an optical device according to some embodiments of the inventive concept;

FIG. 3 is a cross-sectional view taken along a line X-X′ of FIG. 1;

FIG. 4 is an enlarged view of a portion ‘A’ of FIG. 3; and

FIG. 5 is a cross-sectional view taken along a line X-X′ of FIG. 1 to illustrate an optical receiver module according to other embodiments of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

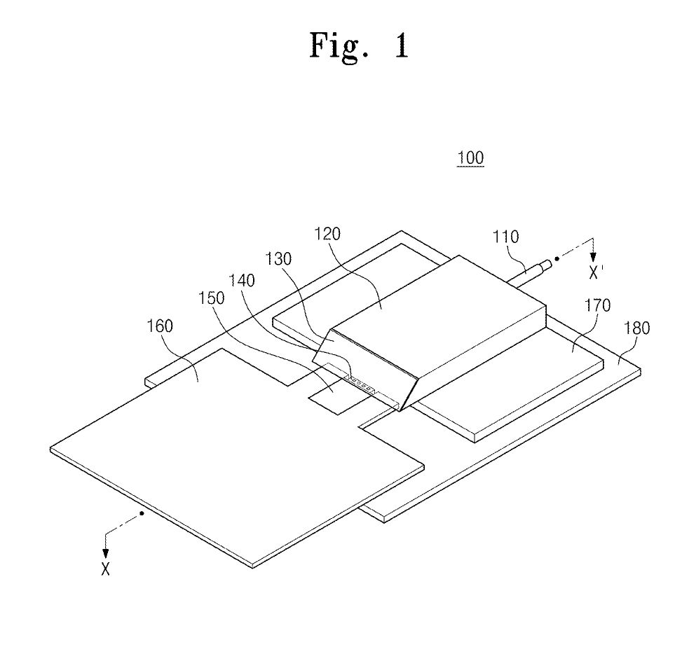

FIG. 1 is a perspective view illustrating an optical receiver module according to some embodiments of the inventive concept. Referring to FIG. 1, an optical receiver module 100 includes an optical connector 110, a demultiplexer 120, an optical device 130, a photodetector 140, a pre-amplifier 150, a printed circuit board 160, a first supporting part 170, and a second supporting part 180. Additionally, the optical receiver module 100 uses a wavelength division multiplexing (WDM) technique which employs multiple light wavelengths to transmit signals of various channels through a single optical fiber. In the present embodiment, the optical receiver module 100 uses a 4-channel input WDM technique. However, the inventive concept is not limited thereto. The optical receiver module may have various channel configurations.

The optical connector 110 receives an optical signal inputted through a single optical fiber and then transmits the optical signal to the demultiplexer 120. Here, the optical signal may be 4-channel input optical signals which have four wavelengths different from each other, respectively. The 4-channel input optical signals may be multiplexed optical signals. The 4-channel input optical signals are transmitted to the optical connector 110 through the single optical fiber. The optical connector 110 may be manufactured to have a pigtail-shape or a receptacle-shape.

The demultiplexer 120 is connected to one end of the optical connector 110 to receive the 4-channel input optical signals. The demultiplexer 120 divides the 4-channel optical signal into optical signals corresponding to channels, respectively. The demultiplexer 120 may have an array waveguide grating (AWG) structure. The demultiplexer 120 transmits the divided optical signal corresponding to each of the channels to a mirror of the optical device 130.

The optical device 130 is combined with the demultiplexer 120. The optical device 130 and the demultiplexer 120 may constitute a united structure. FIG. 1 shows the united structure of the optical device 130 and the demultiplexer 120 as an example. The optical device 130 functions as a connecting part which transmits the optical signal of each channel transmitted from the demultiplexer 120 to the photodetector 140.

However, a conventional optical device for transmitting each channel optical signal transmitted from a demultiplexer to a photodetector should perform many optical alignments between elements thereof. For example, a conventional optical device for 4-channel input optical signals needs four mirrors and four lenses, and four optical alignments are performed between four mirrors and four lenses. After the optical alignments are performed between the elements (i.e., the mirrors and lenses), the optical signal may be transmitted from the demultiplexer to the photodetector. Thus, a fabricating cost and a fabricating time of the optical receiver module may increase due to a plurality of the optical alignments.

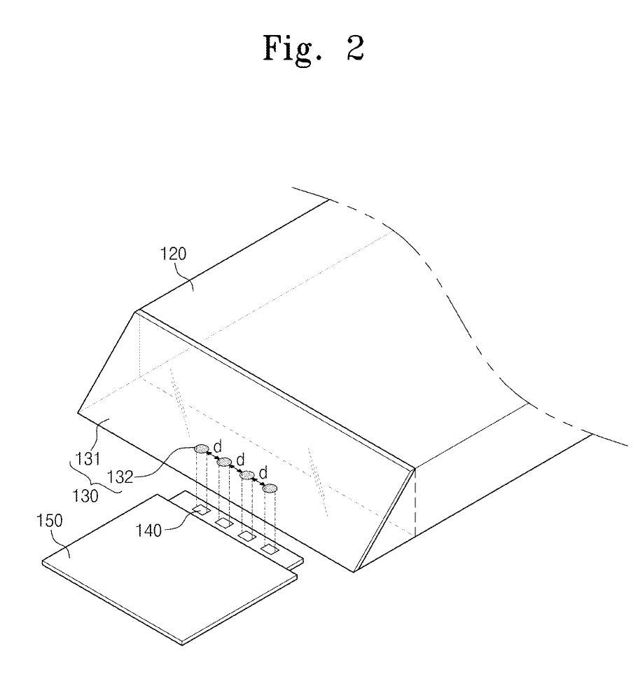

On the contrary, for reducing the optical alignments, the optical device 130 illustrated in FIG. 1 includes a single mirror and 4 lenses. Additionally, the optical device 130 and the demultiplexer 120 are formed into the united structure, such that the single mirror is disposed on one side of the optical device 130 and the 4 lenses are disposed at equal intervals on another side of the optical device 130. In particular, the 4 lenses are formed in an array form having equal intervals on the side of the optical device 130. Since the optical device 130 is fabricated as described above, the number of the optical alignments required between the mirror and the lenses can be reduced. The optical device 130 will be described in more detail with reference to FIG. 2 later.

The photodetector 140 is disposed to be spaced apart from a bottom end of the optical device 130 by a predetermined distance. The photodetector 140 receives the optical signal of each channel from the optical device 130. The photodetector 140 converts the received optical signal of each channel into an electrical signal. The photodetector 140 may be a surface-illuminated type photodetector or a waveguide type photodetector. Additionally, 4 photodetectors 140 are provided for the 4-channel input optical signals. The 4 photodetectors 140 may be fabricated in an array form.

The pre-amplifier 150 is electrically connected to an end of the photodetector 140. The pre-amplifier 150 amplifies the electrical signal of each channel received from the photodetector 140. Additionally, the pre-amplifier 150 may be formed to have a united structure including a plurality of amplifiers. The pre-amplifier 150 transmits the amplified electrical signal of each channel to the printed circuit board 160.

The printed circuit board 160 functions as a transmission path transmitting the amplified electrical signal to an external circuit.

The first and second supporting parts 170 and 180 support the optical receiver module 100. In more detail, the first supporting part 170 may be disposed under the multiplexer 120 to support the multiplexer 120. The second supporting part 180 may be disposed at the lowermost part of the optical receiver module 100 to entirely support the optical receiver module 100.

As described above, the optical receiver module 100 uses the optical device 130 including the single mirror and N lenses (where ‘N’ denotes the number of the channels), such that the number of the optical alignments may be reduced. As a result, the fabricating time and the fabricating cost of the optical receiver module may be reduced.

FIG. 2 illustrates an optically aligned structure of the optical device and the photodetector illustrated in FIG. 1. Referring to FIG. 2, the optical device 130 includes a single mirror 131 and four lenses 132 for the 4-channel input optical signals. Four photodetectors 140 are provided for receiving optical signals through the four lenses 132, respectively. The photodetector 140 is spaced apart from the lens 132 by a predetermined distance. A focal distance of each of the lenses 132 is determined in due consideration of the distance between the lens 132 and the photodetector 140.

The mirror 131 reflects the optical signal transmitted in a horizontal direction through the demultiplexer 120, and the reflected optical signal is transmitted in a vertical direction to the lens 132. An end portion of the optical device 130 may be cut at an angle of 45 degrees and then the cut surface of the optical device 130 may be polished. Subsequently, a silica-based material may be coated on one side of the optical device 130 to form the mirror 131. In other words, the mirror 131 may be formed of the silica-based material. The optical device 130 includes the single mirror 131, not four mirrors corresponding to 4-channel input optical signals. Since the mirror 131 is formed on one side of the optical device 130 combined with the multiplexer 120, optical alignment between the mirror 131 and the multiplexer 120 is not required.

Additionally, the four lenses 132 are formed into a single lens array at equal intervals d by using an alignment mark array (not shown) previously set with the equal intervals. In other words, the four lenses 132 are formed on a single array substrate. Likewise, the four photodetectors 140 are formed into a single photodetector array at equal intervals d by using an alignment mark array (not shown). In other words, the four photodetectors are formed on a single array substrate. As a result, the four lenses 132 are formed into the single lens array at equal intervals d, and the four photodetectors 140 are also formed into the single photodetector array at equal intervals d.

A conventional optical device needs four optical alignments between four lenses and four photodetectors for optically coupling optical signals of 4 channels from a demultiplexer to photodetectors. On the contrary, since the four lenses 132 are formed into the single lens array and the four photodetectors 140 are formed into the single photodetector array in FIG. 2, one optical alignment is performed between the single lens array and the single photodetector array. Thus, the optical receiver module 100 may reduce the number of optical alignments to reduce the fabricating cost of the optical receiver module 100.

As described above, the four lenses 132 and the four photodetectors 140 are formed into the single lens array and the single photodetector array. At this time, the distance between the lenses 132 is equal to the distance between photodetectors 140. Thus, the demultiplexer 120 is optically coupled to the photodetector 140 by the one optical alignment between the lens array and the photodetector array.

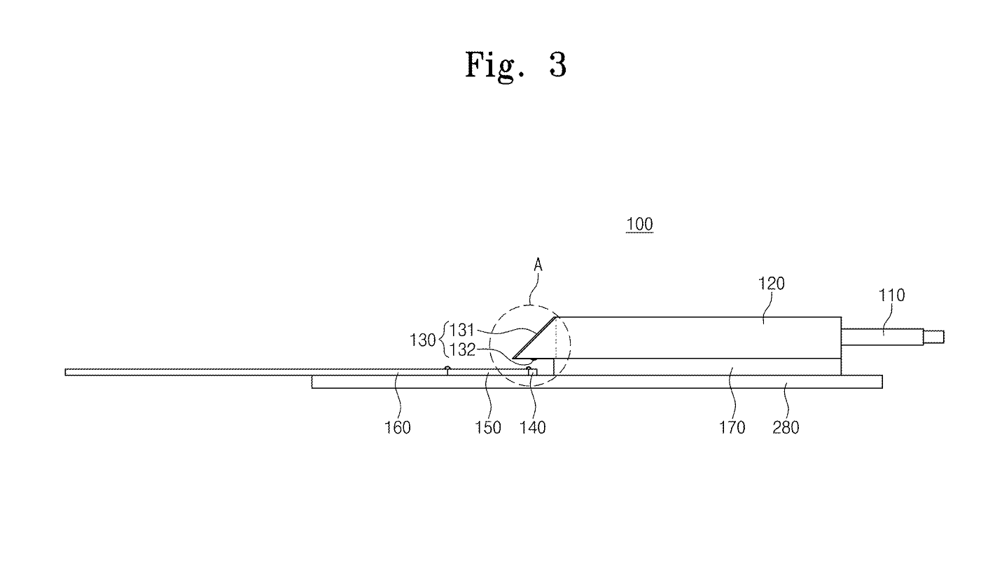

FIG. 3 is a cross-sectional view taken along a line X-X′ of FIG. 1. In other words, FIG. 3 illustrates that one channel optical signal divided by the demultiplexer 120 is optically coupled to the photodetector 140 through the lens 132.

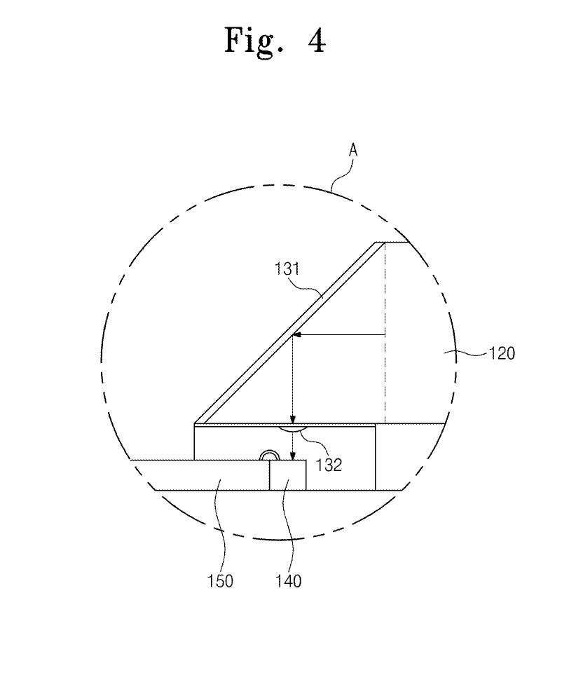

FIG. 4 is an enlarged view of a portion ‘A’ of FIG. 3. Referring to FIGS. 3 and 4, a process of converting the optical signal of each channel into the electrical signal will be described in more detail.

Referring to FIG. 3, the demultiplexer 120 divides the 4-channel input optical signals transmitted through the optical connector 110 into four optical signals respectively corresponding to 4 channels. The optical signal divided suitably for each channel may travel along the arrayed wavelength grating (AWG) of the demultiplexer 120.

Referring to FIG. 4, a traveling direction of the optical signal will be described in more detail hereinafter. The optical signal travels along the arrayed wavelength grating (AWG) and then the traveling direction of the optical signal is changed into a direction perpendicular to the direction of the arrayed wavelength grating (AWG) by the mirror 131. In other words, the optical signal is vertically reflected by the mirror 131 having a right-angled structure and then is transmitted to the lens 132. The optical signal passes through the lens 132 and then is transmitted into the photodetector 140. Thus, the photodetector 140 converts the received optical signal into the electrical signal and then transmits the electrical signal to the pre-amplifier 150.

Referring again to FIG. 3, the optical device 130 and demultiplexer 120 are combined with each other to constitute the united structure. Thus, the optical device 130 is automatically optically aligned with the demultiplexer 120 without an additional optical alignment process. Thus, the mirror 131 may reflect the optical signal outputted from the demultiplexer 120 to the single lens array. The single lens array including the four lenses 132 may be optically coupled with the single photodetector array including the four photodetectors 140 by one optical alignment process.

As described above, the optical receiver module 100 includes the single lens array and the single photodetector array coupled with each other by one optical alignment. Thus, the fabricating cost of the optical receiver module 100 may be reduced.

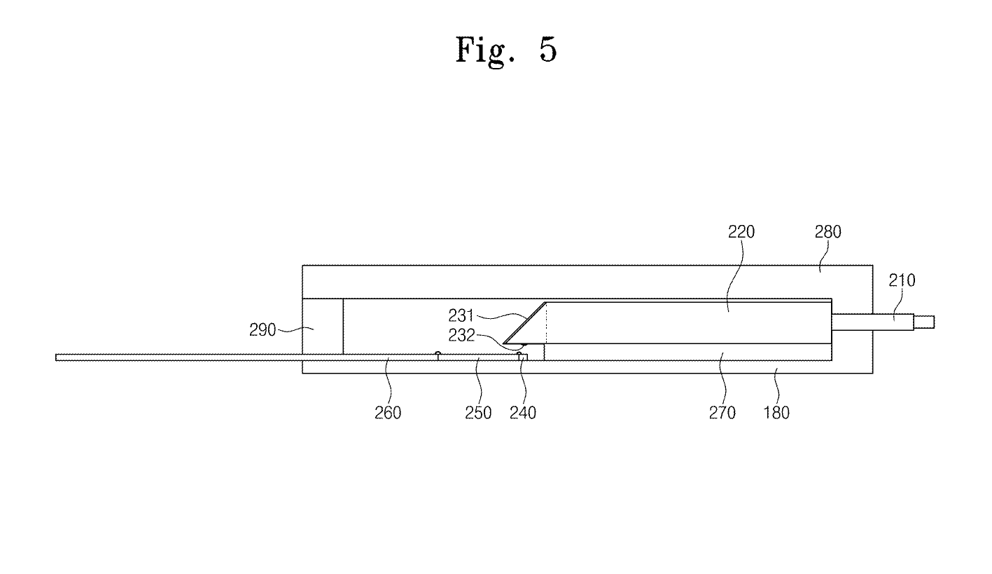

FIG. 5 is a cross-sectional view taken along a line X-X′ of FIG. 1 to illustrate an optical receiver module according to other embodiments of the inventive concept. Referring to FIG. 5, an optical receiver module 200 further includes a supporting member 290. Other elements of the optical receiver module 200 are the same as corresponding elements of the optical receiver module 100 illustrated in FIG. 3.

The supporting member 290 is used for increasing optical coupling efficiency between an optical device 230 and a photodetector 240. In other words, a height of the supporting member 290 is controlled to increase the optical coupling efficiency between the optical device 230 and the photodetector 240 of the optical receiver module 200. Additionally, the supporting member 290 is formed of the same material as first and second supporting parts 270 and 280.

According to embodiments of the inventive concept, the optical receiver module has the structure capable of easily optically coupling the demultiplexer to the photodetector. Thus, the optical receiver module may be easily fabricated and the fabricating cost of the optical receiver module may be reduced.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. An optical receiver module comprising:
a demultiplexer dividing a plurality of multiplexed optical signals into individual optical signals;
an optical device including a right-angled mirror and a plurality of lenses, the right-angled mirror reflecting the individual optical signals transmitted in a horizontal direction from the demultiplexer in a vertical direction, and the plurality of lenses receiving the individual optical signals reflected from the right-angled mirror; and
a plurality of photodetectors spaced apart from the plurality of lenses by a predetermined distance, the plurality of photodetectors receiving the individual optical signals transmitted from the plurality of lenses, and the plurality of photodetectors converting the individual optical signals into electrical signals,
wherein the optical device and the demultiplexer are formed into a united structure; and
wherein a distance between the lenses is equal to a distance between the photodetectors.

2. The optical receiver module of claim 1, further comprising:
an optical connector for transmitting the plurality of multiplexed optical signals transmitted through a single optical fiber to the demultiplexer.

3. The optical receiver module of claim 2, wherein the optical connector is formed to have a pigtail-shape or a receptacle-shape.

4. The optical receiver module of claim 1, further comprising:
a pre-amplifier electrically connected to the plurality of photodetectors,
wherein the pre-amplifier receives the electrical signals outputted from the plurality of photodetectors.

5. The optical receiver module of claim 4, wherein the pre-amplifier amplifies the received electrical signals.

6. The optical receiver module of claim 5, further comprising:
a printed circuit board electrically connected to the pre-amplifier,
wherein the printed circuit board is provided for transmitting the electrical signals amplified by the pre-amplifier to an external circuit.

7. The optical receiver module of claim 1, wherein the plurality of lenses are formed on a single array substrate at equal intervals;
wherein the plurality of photodetectors are formed on a single array substrate at equal intervals; and
wherein the interval between the lenses is equal to the interval between the photodetector.

8. The optical receiver module of claim 1, wherein the right-angled mirror is formed of a silica-based material; and
wherein the right-angled mirror is coated on one side of the optical device.

9. The optical receiver module of claim 1, further comprising:
a supporting member for controlling a height between the optical device and the photodetector.

10. The optical receiver module of claim 1, wherein the demultiplexer has an arrayed wavelength grating (AWG) structure.
